(19) United States
(12) Patent Application Publication
(10) Pub. No.: US 2009/0307772 A1
(43) Pub. Date: Dec. 10, 2009

(54) FRAMEWORK FOR SCALABLE STATE ESTIMATION USING MULTI NETWORK OBSERVATIONS

(75) Inventors: Tom Markham, Fridley, MN (US); Kirk Schloegel, Golden Valley, MN (US); Walt Heimerdinger, Minneapolis, MN (US); Valerie Guralnik, Mound, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/547,415

(22) Filed: Aug. 25, 2009

Related U.S. Application Data
(63) Continuation-in-part of application No. 12/369,692, filed on Feb. 11, 2009.
Application No. 12/369,692 is a continuation-in-part of application No. 12/124,293, filed on May 21, 2008.
Application No. 12/124,293 is a continuation-in-part of application No. 12/369,692, filed on Feb. 11, 2009.
Application No. 12/369,692 is a continuation-in-part of application No. 12/187,991, filed on Aug. 7, 2008.
(60) Provisional application No. 61/091,657, filed on Aug. 25, 2008.

(51) Int. Cl. G06F 12/14

(52) U.S. Cl. 726/22

(57) ABSTRACT

A framework for state estimation using multi-network observation. Highly scalable qualitative probabilistic algorithms may be used to combine noisy, uncertain outputs having multi-modal event data from numerous networks into a relatively accurate and coherent estimate of the system state. Models of disparate networks may be pulled together to result in unified multi-modal event data. Information from multiple networks may be graphed and analyzed.

This application claims the benefit of U.S. Provisional Patent Application No. 61/091,657, filed Aug. 25, 2008. U.S. Provisional Patent Application No. 61/091,657, filed Aug. 25, 2008, is hereby incorporated by reference.

This application is a Continuation-in-Part of U.S. patent application Ser. No. 12/369,692, filed Feb. 11, 2009, which in turn is a Continuation-in-Part of U.S. patent application Ser. No. 12/124,293, filed May 21, 2008.

This application is a Continuation-in-Part of U.S. patent application Ser. No. 12/369,692, filed Feb. 11, 2009, which in turn is a Continuation-in-Part of U.S. patent application Ser. No. 12/187,991, filed Aug. 7, 2008.

U.S. patent application Ser. No. 12/369,692, filed Feb. 11, 2009, is hereby incorporated by reference. U.S. patent application Ser. No. 12/124,293, filed May 21, 2008 is hereby incorporated by reference. U.S. patent application Ser. No. 12/187,991, filed Aug. 7, 2008 is hereby incorporated by reference.

### BACKGROUND

The invention pertains to networks and particularly to observation of networks. More particularly, the invention pertains to observation of various kinds of networks.

### SUMMARY

The invention may be a framework for scalable state estimation using multi-network observations. The invention may involve a unification of models of disparate networks and the analysis of information obtained from the unified multiple networks.

### BRIEF DESCRIPTION OF THE DRAWING

FIG. 1 is a diagram of framework architecture for unification of models of disparate networks and the analysis of information obtained from the networks;

FIG. 2 is a flow diagram of the framework architecture of the present system;

FIG. 3 is a diagram of an ontological example of a unification of disparate networks relative to elements and their ontological links;

FIG. 4 is a diagram showing model goal interaction across multiple networks;

FIG. 5 is a diagram of a stochastic network attack model;

FIGS. 6a, 6b and 6c are diagrams of three diverse networks;

FIG. 6d is a diagram of a resultant unified network of corresponding nodes of the diagrams in FIGS. 6a, 6b and 6c;

FIG. 7 is a diagram of a transformation of correlated graphs into a single, weighted graph;

FIG. 8 is a diagram of graph with a heavy line enclosing a particular node and mutually exclusive nodes;

FIG. 9 is a diagram of showing several networks having some overlap with vertexes that are located on various networks as indicated by notation associated with the respective vertex;

FIG. 10 is a diagram illustrating two networks having partitions which divide each network into clusters and having lines indicating a mapping of nodes across the networks including a specific mapping across clusters; and

FIG. 11 is a diagram showing a pattern of how a computer network security tool may operate.

### DESCRIPTION

Organizations (such as the U.S. Department of Defense) often need to piece together bits of information on different networks in order to detect anomalies and make predictions. The networks may be, for example, computer networks, social networks, logistics networks, and financial networks. In the past, many conventional approaches treated each network as a “stove piped” or a “silo” problem, meaning that each network was treated as an independent and isolated problem. As an example, analysis of computer network events typically ignored the social networks, even though the social networks intersected or involved the computer networks. Likewise, the logistics networks (which support one or more organizations) were analyzed independently of the computer networks.

Networks are constantly under attack. However, the available tools (e.g., firewalls, VPNs, intrusion detection, anti-virus, and so on) may be mainly defensive. One cannot necessarily win a defensive war. Eventually the attackers may succeed. Many organizations appear to lack the tools necessary to mount an effective counterattack against cyber attackers. In many cases, one does not know in a timely manner who is attacking, what the attackers' objectives are, what targets they may strike next, what tools and techniques they may use, and what their true location is in cyberspace.

This disclosure provides a technique or tool for piecing together information from diverse networks in a way that links data from multiple contexts (such as computer networks, social networks, logistics networks, and financial networks). This may be done to provide improved situational awareness compared to what could be obtained by analyzing each network in isolation of the others.

In some approaches, this technique or tool may incorporate an approach for performing scalable coherent state estimation. Highly scalable qualitative probabilistic algorithms may be used to combine noisy, uncertain outputs from numerous networks into a relatively accurate and coherent estimate of a system state. This technology may be integrated into a larger framework that provides analysts and other personnel with a holistic approach to answering questions related to the networks. This tool or approach may address various challenges that the personnel face when confronted with bits of information from disparate networks. The approach may involve the unification of models of disparate networks and the analysis of information obtained from multiple networks.

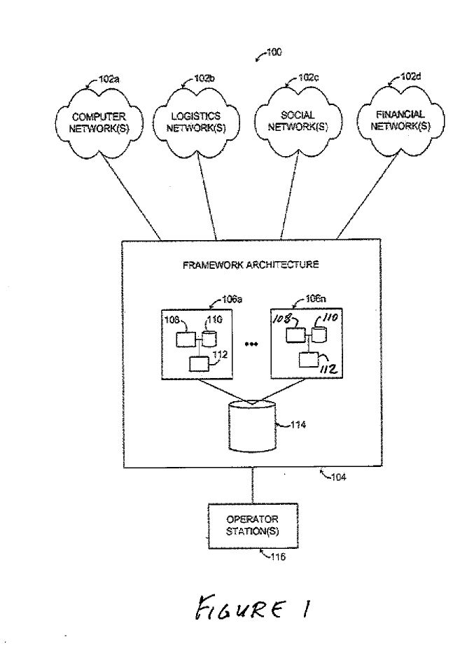

One example approach of a system 100 incorporating the tool is shown in FIG. 1. Here, the system 100 includes multiple networks 102a-102d which represent different types of networks. In this example, the networks may include computer, logistics, social, and financial networks. One may note that these networks are mentioned for illustrative purposes. Other or additional types of networks may also be used.

Data associated with the networks 102a-102d may be provided to a framework architecture 104 for analysis. For example, the framework architecture 104 may receive multi-modal event data associated with the networks 102a-102d and perform functions for unifying this event data. This may produce unified multi-modal network data that can be analyzed, such as by performing qualitative probability analysis and probability aware graph-based data mining. Feedback based on the analysis can also be provided, such as to update or modify unification models used for unifying the multi-modal event data.

The framework architecture 104 may include any hardware, software, firmware, or combination thereof for analyzing data from multiple types of networks. The framework architecture 104 may, for example, include one or more computing devices 106a-106n executing various applications or software programs or otherwise performing various functions. “n” may represent the number of devices. Each computing device may include one or more processors 108 and one or more memories 110 storing instructions and data used, generated, or collected by the one or more processors 108. Each computing device may also include at least one network interface 112 facilitating communication over one or more wired or wireless networks, such as one or more Ethernet interfaces. Note that each computing device may be responsible for performing one or more processes to support the overall functionality of the framework architecture 104. Also note that multiple computing devices may be responsible for performing at least some of the processes, or each computing device may be responsible for performing different processes. One may further note that the computing devices may have different hardware or other configurations, such as configurations based on the functions performed by those computing devices.

Data associated with the example networks 102a-102d may be provided to the framework architecture 104 in any suitable manner. For example, data associated with various networks may be collected automatically and provided to the framework architecture 104 (note that suitable security or other mechanisms may be provided for protecting the framework architecture 104 from intrusion, harmful data, or other attacks). Data may also be provided manually, such as by analysts or other personnel manually providing data using one or more operator stations 116 (again note that username-password combinations or other security mechanisms may be used to protect access to the framework architecture 104). In addition, data generated by the framework architecture 104 may be used in any suitable manner, such as stored for later retrieval or use, or presented to operators.

In this example, a database 114 may be used to store various information used, generated, or collected by the computing devices 106a-106n in the framework architecture 104. A single database 114 may store information for one or multiple computing devices, and/or multiple databases 114 may store information for one or multiple computing devices. The database 114 may include any hardware, software, firmware, or combination thereof for storing and facilitating retrieval of information. The database 114 may also use any of a variety of data structures, arrangements, and compilations to store and facilitate retrieval of information.

The operator stations 116 may represent computing or communication devices providing user access or interface to the framework architecture 104. Each of the operator stations 116 may include any hardware, software, firmware, or combination thereof for supporting user access or control of the framework architecture 104. The operator stations 116 may, for example, represent desktop computers, laptop computers, personal digital assistants, pagers, mobile telephones, or other devices. One may note that a wide variety of operator stations 116 may be used to interact with the framework architecture 104 and that these interactions may vary depending on the type of operator station 116 currently used by a user.

In a particular example, the framework architecture 104 may apply incorporate, use or otherwise be associated with a modified version of SCYLLARUS™ by Honeywell International Inc. SCYLLARUS™ may be regarded as a computer network security tool (CNST). CNST may be described and referred to herein in conjunction with the present approach and system. Other kinds of tools may be used as a CNST. As a particular example, the framework architecture 104 may apply Bayesian logic to cyber events (such as network-based intrusion detection) and to events associated with other networks (such as non-computer networks). As another particular example, the framework architecture 104 can be used to determine if two or more graphs are related, such as by using probabilities that various nodes in each graph are equivalent.

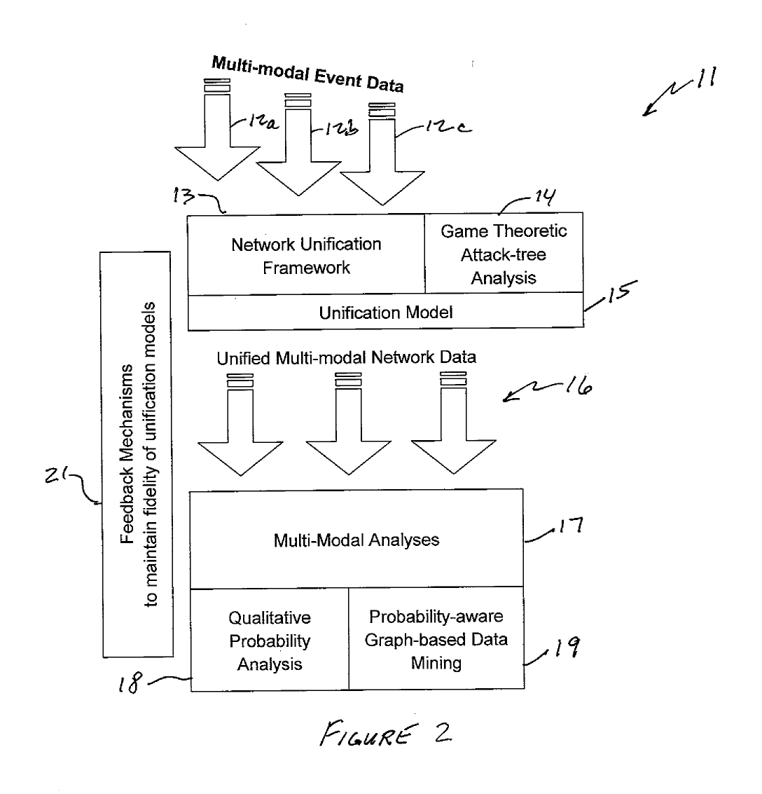

FIG. 2 is a flow diagram of the framework architecture of the present system. Multi-modal event data 12a, 12b, 12c may enter the system at a unification network framework 13. Adjacent to framework 13 may be a game theoretic attack-tree analysis module 14. An attack tree may be simulated to analyze and predict for each network model, the effects of threats on a system of diverse networks. Unification framework 13 may provide a common representation for reasoning about multi-modal data. The game theoretic component module 14 may support complex interaction among 12a, 12b and 12c event data goals. A unification model 15 may be associated with framework 13 and module 14. The unification model 15 may capture the “known unknowns” and transform events into analysis artifacts.

Unified multi-modal network data 16 may emerge from unification model 15 and go to a multi-modal analyses module 17. The multi-modal analyses module 17 may use module 18 for qualitative probability analysis of data 16 and data stored in 114. Also, data 16 may use a probability-aware graph-based data mining module 19 on data 16 and data stored in 114. The qualitative probability analysis module 18 may ensure usability of the data by human analysts by pruning down probability space. The probability-aware graph-based data mining module 19 may uncover the “unknown unknowns” of the data and feed them back to the unification framework 13 and model 15. There may be feedback mechanisms for maintaining fidelity of the unification model.

The present description introduces an approach for performing scalable state estimation based on multi-network observations. One may use highly scalable qualitative probabilistic algorithms to combine the noisy, uncertain outputs from numerous networks into a relatively accurate and coherent estimate of system state. This technology may be integrated into a larger framework which provides the analyst with a holistic approach to answering the questions herein. The present approach may address two major challenges, which include the unification of models of disparate networks and analysis of information obtained from multiple networks.

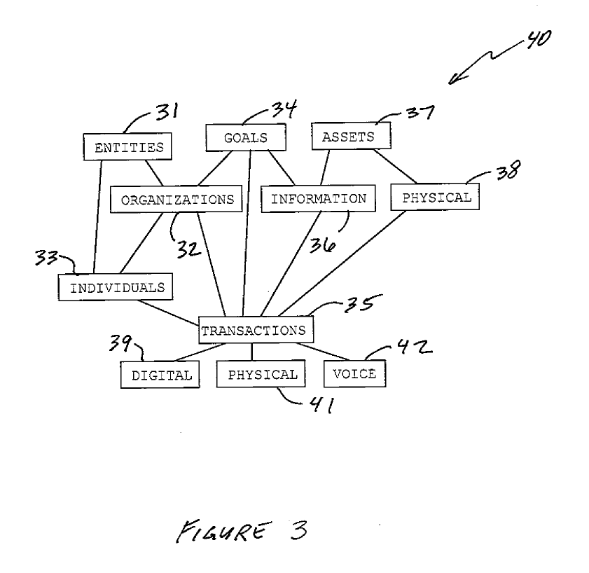

Unification that may be performed by module 13 in FIG. 2 may be a fundamental concern, since each network to be considered will have actors, attributes, capabilities, and observables specific to that network. These should be captured in a unified model that records the attributes and semantics of each network object and the relationships between them. This may be best provided by a reference model such as module 15 in FIG. 2 and module 40 in FIG. 3—a rich ontology that includes a subsidiary ontology for each network consisting of instances inherited from a common set of abstract objects, thus allowing general data mining algorithms to reason over related objects derived from disparate networks. The subsidiary ontologies make management of the reference model scalable. The ontology may also include weights to support reasoning about the relative probability of relationships. Such a reference model appears essential to any multi-network analysis.

The analysis process needs to recognize that observations from disparate networks may have multiple interpretations, each with a different probability and that each relationship may also have a prior probability, so a sophisticated probability calculus is required. The analysis engine should be guided by the reference model to discover meaningful clusters of observations and hypotheses about their cause. The analysis process should consider multiple outcomes for each set of observations to avoid both blind spots (i.e., missed inferences) and false alarms (i.e., incorrect inferences). Two approaches that may be implemented include 1) a cyber alert correlation and analysis system such as module 18 in FIG. 2 that may use a reference model to discover hypotheses related to observations and then create Bayesian belief nets to estimate the relative probability of each hypothesis, and 2) one such as module 19 in FIG. 2 which may use probability-aware graph-based data mining algorithms to a) find patterns as well as structural anomalies in multi-modal data, and b) separate a potentially rich set of interconnected observations into clusters of related observations. Both approaches appear to be promising for state estimation based on multi-network observations.

The challenges that should be achieved include developing effective, scalable means of combining multi-modal information from cyber, physical, social and military contexts, processing the flood of input data to find the information which has both high probability and high impact, and extending current graph-based data mining problem formulations and algorithms to handle probabilistic correlations among nodes and arcs.

Two key challenges associated with state estimation based on multi-network observations include the following. The first may involve the correlation of actors, data, ties, and relationships across networks (i.e., is data derived from one network associated to the same “real world” actor, event, relationship, and so forth, as a disparate unit of data derived from another network). The second challenge may involve the fast, accurate, and effective analysis of the correlated networks. One may anticipate then that a framework for multi-modal network analysis will include two key components. One is a network unification framework such as the combination of modules 13, 14, and 15 in FIG. 2 that may build and iteratively update integrated models of disparate networks, and another is a probabilistic analysis engine such as the combination of modules 17, 18, and 19 in FIG. 2 that may reason about observations from multiple networks. Probabilistic analysis may be required due to the inherent uncertainty in associating the underlying real world phenomena to the unified model. For example, it may well be the case that the source of a particular financial transaction can be traced conclusively to, for example, either a hostile agent or the agent's estranged (but otherwise harmless) present or ex-spouse. The transaction may then be quite relevant or virtually benign. In this case, the unification framework might assign a simple fifty-fifty chance that the transaction originated from either source, and so the analysis engine should work with such data.

The network unification framework may create a unified multi-network picture from information obtained from diverse, but (directly or indirectly) interconnected networks. One may begin by defining a canonical network ontology such as module 15 in FIG. 2 that identifies the fundamental components (nodes, arcs, links, actors, targets, sources, sinks, and so forth), relationships, and interactions (discovery, collaboration, delegation, and so forth) of any network. This ontology may serve as the unifying basis for a series of instance models describing specific networks, including computing, social, financial, and logistic networks. Ontological data may map observable artifacts in the specific network instance to elements of the canonical network model and through common canonical elements to artifacts in other networks.

An analysis engine may use probabilistic analyses as well as probability-aware graph-based data mining algorithms to reason about events, patterns, and anomalies emergent across multiple networks. Since each network event generally may have a different level of plausibility and impact, the analysis engine such as module 17 in FIG. 2 may use module 18 to provide a quantitative probability calculus to build dynamic Bayesian networks that expose patterns of activity of interest to an analyst. The best-in-class CNST information aggregation technology may provide qualitative probability reasoning algorithms to distill the noisy and sometimes contradictory data streams from many sources. Multi-constraint, multi-objective extensions of useful graph-based data mining formulations and algorithms may be utilized by the analysis engine module 17 in FIG. 2. These may enable cross-network clustering and pattern detection—even in the presence of uncertainty resulting from imperfect cross-network correlation.

Several key extensions to the CNST evidence aggregation and interpretation technology may serve as the network unification framework. CNST may be successfully applied to a cyber-network security domain in a combined attack-recognition. It may maintain global system information in a threat reference model (TRM) that is an extension of an intrusion reference model (IRM). The TRM may store attributes of the world being protected and provide the knowledge needed to combine the judgments of a wide variety of detectors—that use widely varying sources of information and algorithms—into a much smaller set of events. The resulting events may be scored for plausibility and severity using qualitative probabilities. Qualitative probabilities provide a “ladder” of events of qualitatively different orders of likelihood. This may allow one to combine information from sources with widely varying dynamic ranges and false alarm rates. CNST may reason over rich cyber network ontologies built on top of generalized network base classes to transform events, reports, and so forth, into a cyber network model. These ontologies and associated transformation functions may be extended to include other types of networks.

To aid building ontology extensions, a game-theoretic model such as module 14 in FIG. 2 that may use attack trees, may be effected to analyze and predict for each network model, the effects of threats on the system of networks. The performance of the system of networks during attack may be modeled using synthesized information about network vulnerabilities together with observed performance and availability data. The key challenges may be to enhance existing tools to support richer and more diverse models, improve attack modeling, and model vulnerability propagation.

FIG. 3 is a diagram 40 of an ontological example of an approach for unification of disparate networks relative to key elements and their ontological links. These elements and links may be common, though not necessarily so, to the disparate networks. There may be entities 31, for instance, linked to organizations 32 and individuals 33. Goals 34 may be linked to organizations 32, transactions 35 and information 36. Assets 37 may be linked to information 36 and physical type 38. Organizations 32 may be linked to individuals 33 and transactions 35. Individuals 33 may be linked to transactions 35. Information 36 may be linked to transactions 35. Physical type 38 may be linked to transactions 35. Transactions 35 may be linked to digital type 39, physical type 41 and voice type 42. There may be other items and links added or removed from diagram 40. The invention may use an ontology similar to diagram 40 of FIG. 3 but more complex to automatically reason about how diverse networks interact and/or share common attributes.

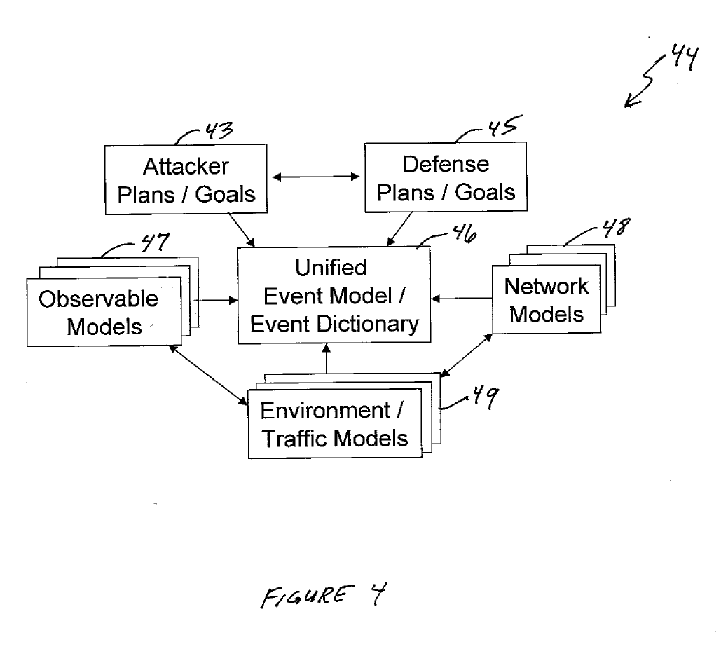

FIG. 4 is a diagram 44 showing a model of goal interaction across multiple networks, including interplay between goals and how they reinforce and interfere with each other, and how goals contribute to higher level goals. The invention may use this type of model to reason about how goals interact. The results may be used to filter the possible state estimation hypotheses to be created or updated by new multi-modal events.

Attacker plans/goals 43 and defense plans/goals 45 may interact with each other. Attacker plans/goals 43 and defense plans/goals 45 may be provided to a unified event model/event dictionary 46. Observable models 47 and network models 48 may be provided to unified event model/event dictionary 46. Observable models 47 and environment/traffic models 49 may interact with each other. Network models 48 and environment/traffic models 49 may interact with each other. Environment/traffic models 49 may be provided to unified event model/event dictionary 46.

Network attack modeling and analysis may be noted. To build ontology extensions, a game-theoretic or stochastic network attack model may be used. Attack trees may be simulated to analyze and predict for each network model, the effects of threats on a system 100 of diverse networks (FIG. 1).

A cyber network attack model may be used as a baseline to develop general attack models for other networks. Properties of the cyber network attack model may include situation calculus and goal directed procedure invocation. Simulated attackers may choose among methods that can achieve goals, and react to failures appropriately, by persistence, choosing alternate means of goal achievement or goal abandonment.

The situation calculus may provide an expressive framework for encoding actions including those whose effects are complex functions of the system state. Golog, Congo/og and Indigolog may provide in approach for implementing situation calculus.

The goal directed invocation may give the ability to invoke procedures based on desired effect, rather than by name. A prototype may simulate a single attacker, who can synthesize full network attacks from a library of plans and primitive actions, reacting to successes and failures encountered. Vulnerability propagation may be modeled.

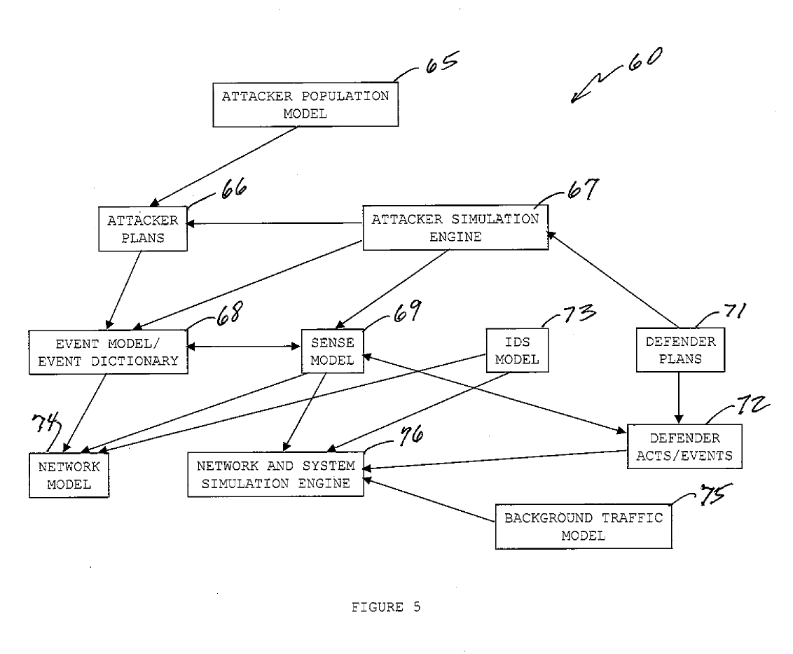

FIG. 5 is a diagram 60 of a stochastic network attack model for a single type of network, a computer network. Module 44 in FIG. 4 may be comprised of one or more unified network attack models. It may be noted that the arrows in diagram 60 loosely denote “depends on” relationships and are not indicative of interfaces. The active model may be required because timescales are such that humans have the ability to react, as opposed to relatively static defenses on many security networks at the present time.

An attacker population model 65 may affect attacker plans 66. An attacker simulation engine 67 may affect attacker plans 66, an event model/event dictionary 68, and a sense model 69. Attacker plans 66 may affect event model/event dictionary 68. Defender plans 71 may affect attacker simulation engine 67 and defender acts/events 72. Sense model 69 and defender acts/events 72 may affect each other. Event model/event dictionary 68 and sense model 69 may affect each other. Event model/event dictionary 68, sense model 69 and an intrusion detection system (IDS) model 73 may affect a network model 74. Sense model 69, IDS model 73, defender acts/events 72 and a background traffic model 75 may affect a network and simulation engine 76.

In addition to developing richer and more diverse ontologies, a number of other key extensions may be made to CNST. Network environments may be dynamic with changes (known as concept drift) significantly affecting the predictive accuracy of the TRM. Thus, the TRM should adapt and evolve as the world changes. Furthermore, it should be extended to include the more complex and abstract events that will be monitored and reasoned over. The present system may utilize a feedback mechanism such as module 21 in FIG. 2 to monitor and correct concept drift by tracking the actual occurrences of events and periodically testing them against predicted events. If the distributions are distinguishable to a specified level of confidence, then the models may be updated with the new distribution. Accuracy and coverage may also be improved by looking for hidden changes in context that correspond with the concept drift. This may allow the models to be expanded to include a newly-discovered element of context. In addition, CNST may be modified to support the dynamic modification of prior probabilities. This may allow CNST to adjust its estimate of prior probabilities to reflect the ever-changing threat environment.

There may be probability-aware graph-based data mining performed by module 19 in FIG. 2. CNST may provide the ability to probabilistically reason over the meaning and severity of incoming network events. This functionality may be extended to support a wide range of network types. Other types of reasoning and data mining may also become applicable as the diversity of network domains increases. Graph-based data mining algorithms may be especially applicable as (1) networks are generally able to be captured as graphs, and (2) many useful graph algorithms have been applied to a range of networks.

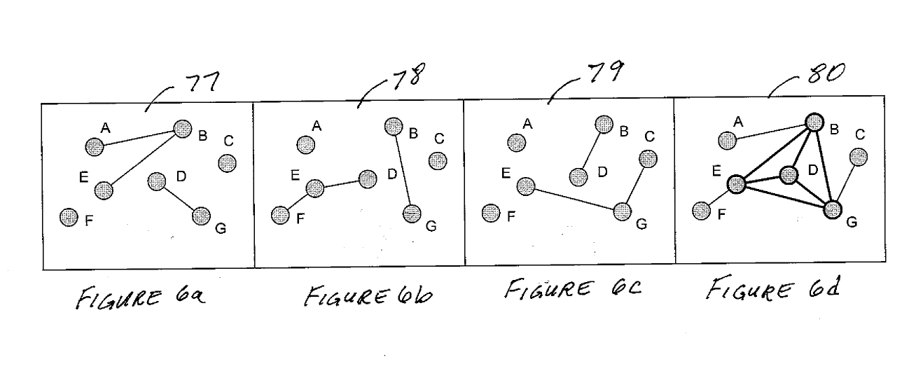

In particular, graph-based partitioning, clustering, and pattern detection algorithms may be fast, scalable, and effective in analyzing network data. However, current formulations and algorithms may require complete and certain knowledge of the structure of the graph. The present network unification framework 13 (FIG. 2), for instance, may provide certain and complete knowledge whenever possible, but in the general case, the unified model may have many probabilistic correlations across the nodes and arcs present in the unified model. As an example, FIGS. 6a, 6b and 6c show three diverse networks 77, 78, and 79, respectively. FIG. 6a shows links B-A, B-E and D-G. FIG. 6b shows links E-F, E-D and B-G. FIG. 6c shows links G-C, G-E and B-D. Combining the networks 77, 78 and 79 of FIGS. 6a, 6b and 6c, respectively, results in the cluster BEDG of network 80 in FIG. 6d, as indicated by links BE, BD, BG, DG, ED and EG.

If the corresponding nodes of each network can be correlated to the same real world phenomena with a high degree of confidence, a unified network 80 in FIG. 6d may be the result (e.g., networks 77, 78 and 79 are overlaid to reveal all of the node arcs). And thus a clustering algorithm applied to this model may detect the cluster BDEG. For instance, network 77 could be a social network, network 78 could be a computer network and network 79 could be a financial network. Networks 77, 78 and 79 may be other kinds of networks. There may be more or less than three networks considered in the model.

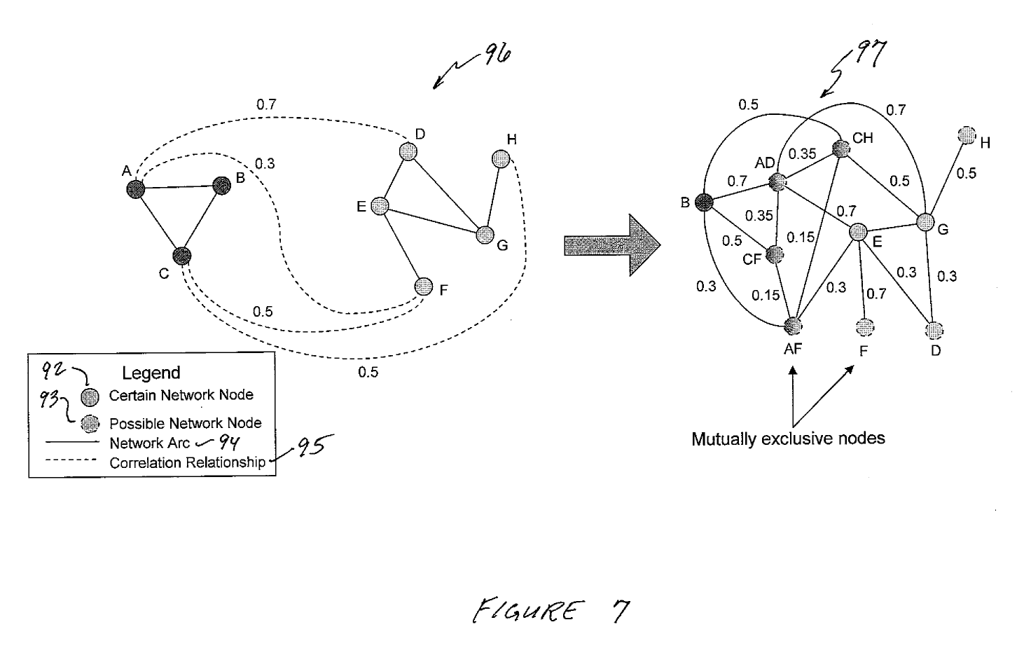

A challenge may occur if the corresponding nodes cannot be correlated with high confidence by the network unification framework. The result is that duplicate nodes and edges may exist that can hinder graph-based analysis algorithms. In FIG. 7, showing clustering across diverse networks, the minimal graph required to unify the networks 77, 78 and 79 in the absence of high confidence correlations may consist of three times as many vertices as the graph of network 80. Furthermore, the data that indicate possible correlations (in this case, this data would represent low confidence in the correlations) dominate the data that represent real world phenomena—inducing noise into the analyses. Moreover, current graph-based analysis algorithms are simply not necessarily formulated to take into account the correlation data at all. However, without taking these items into account, the cluster shown in FIG. 6d would not be discovered.

There may be probability-aware graph-based data mining for video analytics, for example, in module 19 (FIG. 2). Graph-based partitioning, clustering, and pattern detection algorithms may be regarded to be fast, scalable, and effective in analyzing various forms of network data. However, certain formulations and algorithms may require complete and certain knowledge of the structure of the graph. In the video analytics domain, the unified network may have many probabilistic correlations across the nodes A-G and arcs in FIG. 6. Thus, such approaches may be insufficient. If the corresponding nodes of each network of networks 77, 78 and 79 can be correlated to the same real world phenomena with high confidence, the network 80 in FIG. 6d may be the result. Clustering algorithms may detect the cluster BEDG in FIG. 6d.

The approach may collapse multiple networks using probability or weighted arcs across networks. A challenge may occur for multi-modal networks in which corresponding nodes cannot be correlated with high confidence by the network unification framework. Related art graph-based data mining algorithms that do not take into account these probabilities cannot necessarily find the cluster BEDG in a FIGS. 6a-6c.

The approach may include a suite of “probability-aware” problem formulations for useful graph algorithms which may be needed to compute integrated solutions. The following facts may be exploited. First, network nodes and arcs are similar in nature, and thus can be meaningfully combined. Second, nodes in the same network represent different real-world entities. One may transform the system of correlated graphs into a single, weighted graph, as shown in FIG. 7, that graph-based data mining algorithms can handle.

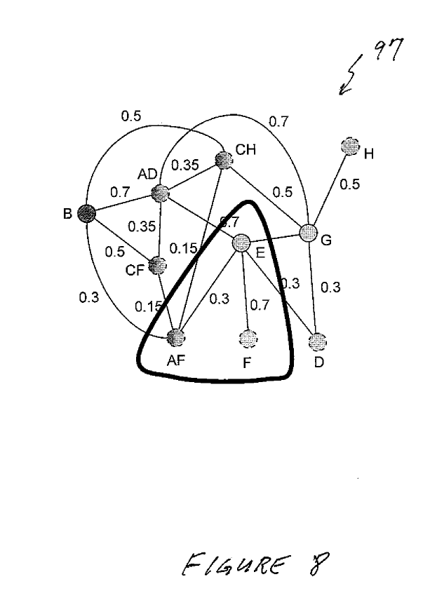

In FIG. 7, a legend 91 indicates that a solid line circle 92 represents a certain network node and a dashed line circle 93 represents a possible network node. A solid line 94 represents a network arc and a dashed line 95 represents a correlation relationship. The left diagram 96 has certain network nodes A, B, C, D, E, F, G and H. There are correlation relationships indicated between nodes A-D of 0.7 probability, nodes A-F of 0.3 probability, nodes C-F of 0.5 probability, and nodes C-H of 0.5 probability. Diagram 96 may be transformed into a diagram 97 where the certain and possible network nodes are connected with network arcs with weights associated with them. A certain network node B may have a 0.5 weighted network arc with possible network node CH, a 0.7 weighted network arc with possible network node AD, a 0.5 weighted network arc with possible network node CF, and a 0.3 weighted network arc with possible network node AF. Possible network node AD may have a 0.7 weighted network arc with certain network node G, a 0.35 weighted network arc with possible network node CH, a 0.7 weighted network arc with certain network node E, and a 0.35 weighted network arc with possible network node CF. Possible network node CF may have a 0.15 weighted network arc with certain network node E, and a 0.15 weighted network arc with possible network node AF. Possible network node AF may have a 0.15 weighted network arc with possible network node CH, and a 0.15 weighted network arc with certain network node E. Possible network node CH may have a 0.5 weighted network arc with certain network node G. Certain network node E may have a network arc with certain network node G, a 0.3 weighted network arc with possible network node D and a 0.7 weighted network arc with possible network node F. Certain network node G may have a 0.5 weighted network arc with possible network node H, and a 0.3 weighted network arc with possible network node D. It may be noted that possible network nodes AF and F are mutually exclusive nodes. FIG. 8 shows diagram 97 with a heavy line enclosing node E and mutually exclusive nodes AF and F. Even a simplest case may be problematic such as what it means when mutually exclusive (ME) nodes are clustered together. Possible approaches may be to guide/influence the results, auto-insertion of meta-edges (e.g., negative edge weights between ME nodes) and semi-supervised clustering. One may note the possible results in FIG. 8.

The following shows a process for transforming the graphs of multiple networks that are linked by probability arcs into a single network graph. 1) For each node in the original graph, one may do the following. a) If the node is not connected to any other nodes by a probability arc, copy the node over to the new graph with the same name and the same weight. b) If the node is connected to one or more other nodes by a probability arc, for each probability arc, create a composite node in the new graph. Name each composite node by appending the names of the two related nodes from the original graph. Compute the weight of the composite node using an appropriate weight composition function (e.g., sum, average, or product) applied to the weights of the two related nodes from the original network graph. Then scale this weight by the probability value of the associated probability arc.

2) For each non-probability edge in the original network graph, one may do the following. a) If neither of the end nodes of the edge is connected to any other nodes by a probability arc, copy the edge over to the new graph with the same end nodes and weight. b) If one or both of the end nodes of the edge are connected to other nodes by one or more probability arcs, for each probability arc, add an edge to the new graph between the corresponding nodes on the new graph. Scale the weight of each new edge by the probability value of the associated probability arc. If an edge already exists between the nodes on the new graph, combine the edges into a single composite edge. Adjust the weight of the composite edge by combining the weights of the two edges using an appropriate weight composition function (e.g., sum, average, or product).

Graph-based data mining algorithms may be developed and extended to handle both uncertain correlations across nodes and arcs as well as typed vertices and edges. Various type graphs may be needed to model semantically diverse network concepts. For example, one edge in a unified model may be derived from a transaction specified in a financial network while another edge may be derived from a social network and represent a history of cooperation between actors. Even when there is high confidence that the source and destination of the transaction are associated with the same real world entities as the nodes incident on the “cooperative relationship” edge, it might not necessarily be meaningfully to combine these edges into a single edge—because a transaction appears fundamentally different than a cooperative relationship. Therefore, both edges should be maintained in the unified model and be handled individually even as integrated analyses that take these both into account are sought.

Graph-based data mining to meet certain needs, state-of-the-art graph-based partitioning, clustering, and pattern detection algorithms may be extended to be probability-aware and to correctly and effectively compute over typed data. Multi-constraint, multi-objective graph partitioning formulations may be used as a way forward. These formulations may associate a vector, vwgt, of size n to each vertex. The value of vwgt[i] may indicate the ith weight of the associated vertex. Similarly, each edge may have an associated weight vector of size m. For present purposes, these vectors of weights may be used to specify both probability and type information in the graph. A straightforward method to do so for typed vertices may be to simply utilize a vertex weight vector of size n, where n is the number of types. Then every element in the vector may be associated with one of the possible node types. Each vector element may be assigned the value of either zero or one depending on whether or not the associated vertex is of the associated type. Of course, more complex schemes may also be possible under this general formulation. For example, since the multi-constraint, multi-objective graph partitioning formulations may handle real numbers as weights, correlation probabilities may likewise be represented under these formulations. This may enable specifying that two nodes (e.g., the source of a transaction and a particular actor in social network) are equivalent with probability p, and to potentially use this knowledge in subsequent analyses.

Multi-constraint, multi-objective partitioning algorithms may be effective in finding highly connected domains while taking into account multiple weights on the vertices and edges of a graph, and without combining the weights. This may lead to application in multi-modal network analysis. However, partitioning may be just one of a number of potential graph-based data mining algorithms that can be employed for this purpose. Generalized multi-constraint, multi-objective formulations and algorithms for other types of useful graph algorithms likewise may be used. A vector of weights may be assigned to every vertex and every edge of the graph. This formulation may become a multi-objective concern. The n edge cuts may be minimized. It may be subject to multiple constraints. One may ensure that each sub-domain has an equal amount of all of the m vertex weights.

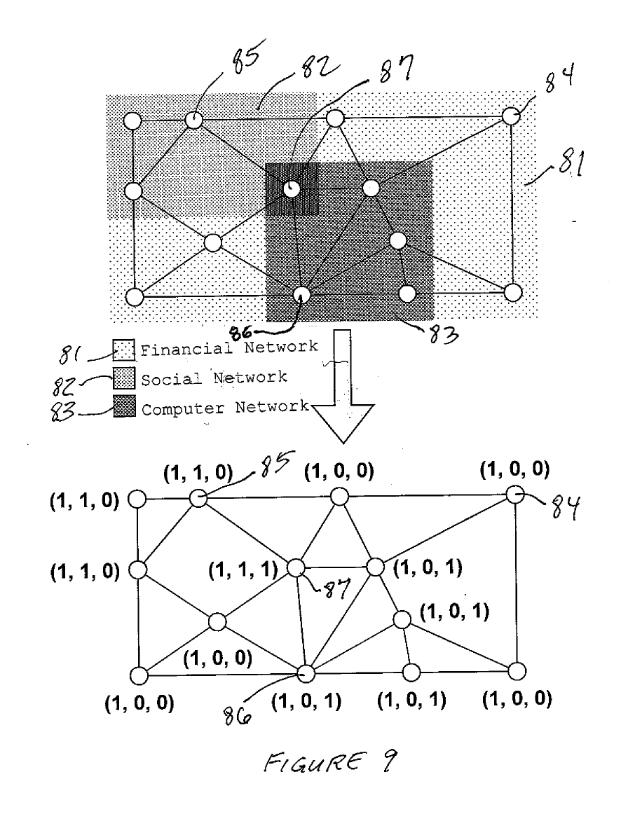

The upper portion of FIG. 9 shows first, second and third networks 81, 82 and 83, respectively, having some overlap, as indicated by the shaded areas. As an illustrative example, networks 81, 82 and 83 may be a financial network, a social network and a computer network, respectively. The vertexes are present in various networks and some are present in multiple networks. Vertex 84, for instance, is present on network 81. Vertex 85 is present on both networks 81 and 82. Vertex 86 is present on both networks 81 and 83. Vertex 87 is present on all three networks 81, 82 and 83. The lower portion of FIG. 9 indicates on which networks that the vertexes are located by the notation “(_,_,_)”. If one or more blanks are filed in with a “1”, then the vertex is located at the respective network or networks. If one or more blanks are filed in with a “0”, then the vertex is not located at the respective network or networks. The first blank represents the first network, the second blank represents the second network and the third blank represents the third network. As indicated by notation (1,1,0), vertex 85 is located on networks 81 and 82 and not on network 83. Vertex 84 is located only on network 81 according to notation (1,0,0). Notation (1,1,1) indicates that vertex 87 is located on networks 81, 82 and 83. In this scheme of representing networks with vertexes and edges, there may be more or less than three networks and more or less than thirteen vertexes.

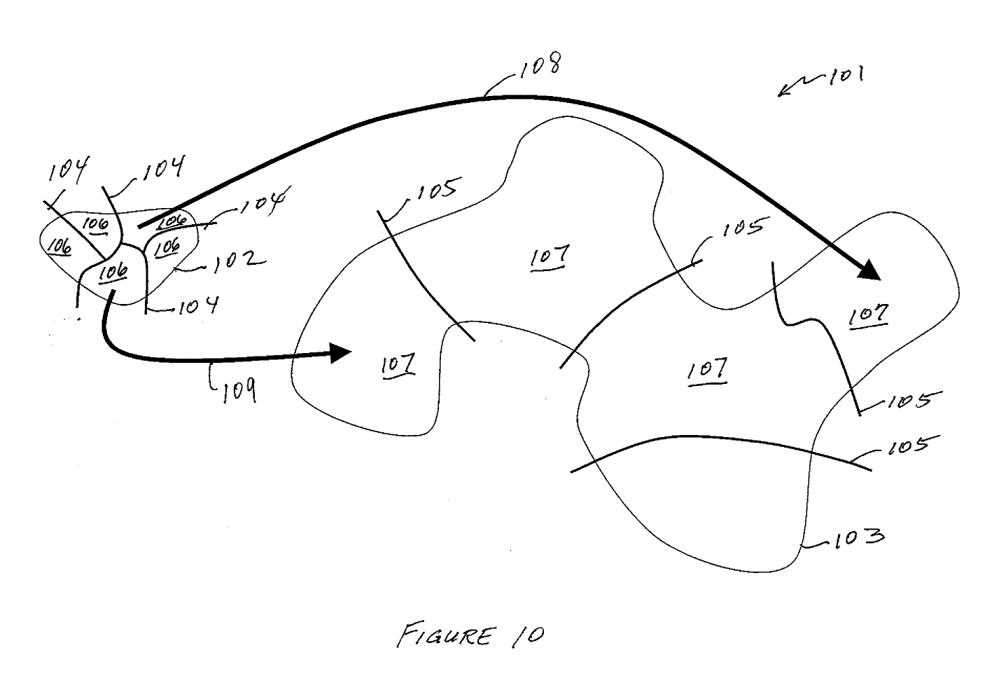

FIG. 10 is a diagram 101 illustrating two networks 102 and 103. Network 102 may have partitions 104 which divide network 102 into clusters 106. Network 103 may have partitions 105 which divide network 103 into clusters 107. Lines 108 and 109 may indicate a mapping of nodes across the networks 102 and 103, including a mapping across certain clusters of their respective networks. By associating various clusters in 106 to various clusters in 107, the invention may integrate clustering results across different types of networks.

CNST may be an aspect of a framework for scalable state estimation using multi-network observations. CNST may relate to one of the multi-networks. It may be a management and analysis system for network security monitoring. CNST may correlate reports from many disparate intrusion detectors to provide information useful to operating personnel or administrators. CNST may also alert and display possible intrusion events and associated reports. It may weigh evidence for or against intrusions to reduce false alarms, access intrusion events for plausibility and severity, and discount attacks against non-susceptible targets. CNST may consolidate and retain report data for forensic investigation. Additionally, it may maintain detector and system configuration information.

CNST may correlate information from multiple disparate intrusion sensors to provide a more accurate and complete assessment of computer network security. This action may lower the false alarm rate, provide a broader range of detected intrusions, such as finding intrusions that a single sensor cannot detect, and estimate effects on security system goals.

CNST may reduce information overload and identify important events. It may consolidate and retain virtually all relevant intrusion detection systems (IDS) reports but distill thousands of IDS reports to far fewer events. CNST may weigh evidence for and/or against intrusions. It may discount attacks against non-susceptible targets. It may identify critical events using Bayesian estimation technology to score intrusion events for plausibility and severity. CNST may also propose likely attacker plans.

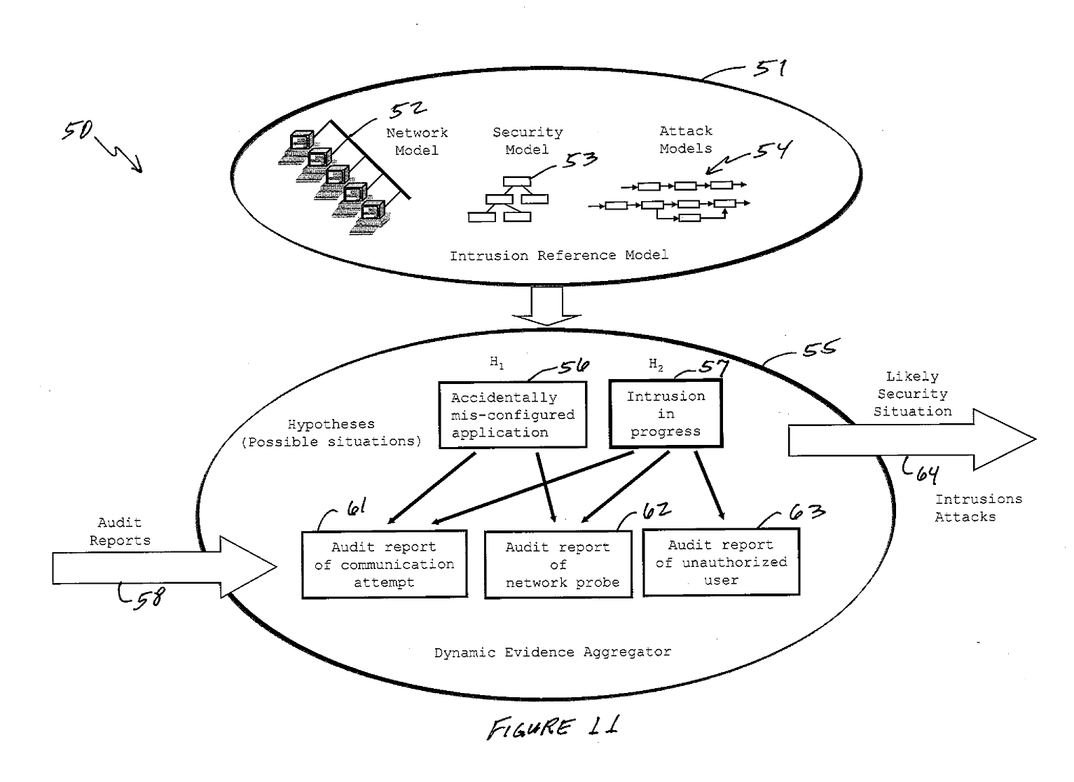

FIG. 11 is a diagram 50 showing a pattern of how CNST may operate. An intrusion reference model (IRM) 51 may describe the components, structure, purpose and operation status of the monitored network. Also, it may describe intrusions to be detected and their relationship to site security goals, system events and resources threatened. This description may be shown with a network model 52, a security model 53 and attack models 54.

From intrusion reference model 51, CNST may go to a dynamic evidence aggregator (DEA) 55 for intrusion detection. The DEA 55 may cluster IDS reports with possible intrusion events, evaluate likelihood of intrusions or alternative events given the IDS reports and status of the network, and link possible intrusions to the status of security goals. An attack plan recognizer may estimate likelihood of alternative attacker goals.

DEA 55 may recognize hypotheses of possible situations. Fore example, one hypothesis 56 may indicate an accidentally mis-configured application. Another hypothesis 57 may indicate an intrusion in progress. There may be additional hypotheses.

Audit reports 58 may come to DEA 55 relative to the hypotheses 56 and 57. Instances of audit reports 61, 62 and 63 may include audit report of communication report of communication attempt, audit report of network probe, and audit report of unauthorized user, respectively.

A cluster preprocessor (CPP) may combine evidence from multiple instances and various kinds of detectors to produce hypothesized events. An event analyzer may use probability to weigh hypotheses generated by the CPP. The event analyzer may “explain away” false positives from innocuous events. A security goal analyzer may identify security goals attacked or compromised. The attack plan recognizer may combine hypothesized events to estimate high level plans/goals of an intruder.

The intrusion reference model 51 static components may include a network entity relationship database (NERD), a security goal database, an attack plan library, and intrusion detector “contracts.” The network entity relationship database may have hardware and services in a protected domain, potential targets such as protected files or applications, services and relationships between entities, deployed detectors, and users, groups and permissions. The security goal database may capture security policies, and have security objects, actors and relationships. The attack plan library may have potential exploits and attach plans, and innocent events that can be confused with attacks (future work). The intrusion detector “contracts” may have IDS locations, scope and capabilities.

The intrusion reference model 51 dynamic components may include intrusion detector reports, hypothesized events, hypothesized security goal violations, and hypothesized attack plans. IDS reports may be clustered by time, target and other similarity criteria. Hypothesized events may be events of interest deduced from reports. Hypothesized security goal violations may be hypothesized from events. Hypothesized attack plans may be likely attack plans.

The cluster preprocessor of the dynamic evident aggregator may combine evidence from multiple instances and various kinds of detectors, as noted herein, and employ the intrusion reference model 51 to understand context, and associate multiple reports with hypothesized events. The cluster preprocessor may build hypotheses by assembling clusters consisting of reports and events. These terms have may have special meanings in CNST. Reports may be direct observations which are the alerts or notifications coming directly from contributing intrusion detection systems (IDSs), firewall logs, and so on. Events are not generally observed. They may be hypothesized causes of reports, some bad, some nice. Various kinds of events may be known in the intrusion reference model 51 event dictionary at different levels of abstraction. Semantics may include attacks, anomalies, operations that may be parts of attacks, and normal activities confusable with attacks.

Reports and events may be clustered to build hypotheses. Reports may include alerts and notifications from intrusion detection systems. Events may be hypothetical causes of reports. Reports may be associated with events by binding to the existing events and hypothesizing new events. Events may be associated with related events where events are manifestations of others, events are parts of conglomerate events, and events are specializations of others.

The event analyzer (assessor) may use probabilistic reasoning to weight likelihood of hypotheses generated by the cluster preprocessor, and “explain away” false positives from innocuous events. The analyzer does not require actual probability but just relative surprise values. Clusters constructed by the cluster preprocessor may represent alternative hypotheses. Different scenarios (e.g., an intrusion detection system false positive, an innocuous event, and an intrusion) may be weighted against each other using qualitative probability. This reasoning may link up to an attack plan recognizer.

The event analyzer may also compute an effect of intrusion events on security goals. Processing may include a hierarchy of goals allowing for inference up the goal tree, inference of a higher level security goal compromise from the compromise of lower level goals, and links to attack plan tracking to allow a status of system security to provide information about attackers' actions/goals.

Set forth may be a multi-modal ontology to unify disparate networks. The networks may exist to transfer, aggregate, coordinate or destroy information, physical assets and money, via transactions that vary in type (digital, physical), direction, size, frequency and so on, between entities, such as individuals, organizations, legal structures, and the like, which have shared and/or conflicting goals. The ontology may link these network elements, and allow reasoning about static and dynamic network information, common or conflicting goals, common owners/actors, shared assets, and so on.

Models may exist that can be unified relative to cyber network attack detection, transportation networks and financial networks. Goals may be an essential unifying element. They may be temporally persistent, more so than individuals and organizations. Diverse groups may cooperate around goals. The goals may naturally cross-domain and enable war-gaming. The CNST tool may provide goal-centric reasoning over cyber network ontology.

In some approaches, various functions described herein may be implemented or supported by a computer program that is formed from computer readable program code and that is incorporated in a computer readable medium. The phrase “computer readable program code” may include any type of computer code, including source code, object code, and executable code. The phrase “computer readable medium” may include any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives may refer to any direct or indirect communication between two or more elements, whether or not those elements are in physical contact with one another. The terms “application” and “program” may refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, may encompass both direct and indirect communication. The terms “include” and “comprise,” as well as derivatives thereof, may mean inclusion without limitation. The term “or” may be inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” may mean any device, system, or part thereof that controls at least one operation. A controller may be implemented in hardware, firmware, software, or some combination of at least two of the same. The functionality associated with any particular controller may be centralized or distributed, whether locally or remotely.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A system for linking data from multiple contexts, comprising:
a framework architecture;
two or more networks connected to the framework architecture; and
a user interface connected to the framework architecture; and
wherein:
the two or more networks are different types of networks;
the framework architecture is a network unification framework; and
the framework architecture is for receiving multi-modal event data from the two or more networks and unifying the multi-modal network data.

2. The system of claim 1, wherein the framework architecture is further for providing analysis of unified multi-modal network data.

3. The system of claim 2, wherein the framework architecture is further for providing probability-aware graph-based data mining relative to the multi-modal network data.

4. The system of claim 2, wherein the framework architecture is for performing a qualitative probability analysis of the multi-modal network data.

5. The system of claim 2, wherein framework architecture comprises an interface for communication over one or more wired or wireless networks.

6. The system of claim 2, wherein the framework architecture further comprises a feedback mechanism for maintaining fidelity of unifying the multi-modal network data.

7. The system of claim 2, wherein the framework architecture is further for game-theoretic attack-tree analysis of the multi-modal event data.

8. The system of claim 2, wherein the framework architecture is further for:
identifying nodes and arcs in each of the two or more networks;
inferring arcs between nodes of the two or more networks; and
assigning weights to at least some of the arcs between the nodes which result from events in which the nodes are involved.

9. The system of claim 8, wherein the two or more networks are collapsed into one network graph.

10. The system of claim 8, wherein:
the two or more networks are transformed into correlated graphs; and
the correlated graphs are transformed into a single weighted graph.

11. The system of claim 7, wherein the attack tree is for hypothesizing data for filling in some gaps in the multi-modal event data.

12. A method for providing a state estimation from different networks, comprising:
obtaining multi-modal event data from different networks;
unifying the multi-modal event data into unified multi-modal event data; and
analyzing the unified multi-modal event data; and
wherein results of the analyzing are fed back to be combined with the unifying the multi modal event data to maintain fidelity of the unified multi-modal event data.

13. The method of claim 12, wherein the analyzing the unified multi-modal data comprises a qualitative probability analysis of the data.

14. The method of claim 12, wherein the analyzing the unified multi-modal data comprises probability-aware graph-based data mining.

15. The method of claim 14, wherein:
the different networks are transformed into network graphs; and
the graphs are correlated and transformed into a weighted graph.

16. The method of claim 12; further comprising:
transforming the different networks that are linked by probability links into a single network graph with nodes and arcs; and
wherein the transforming the network into a first graph comprises:
copying the node over to the first graph with the same name and the same weight;
creating a composite node in the new graph for each probability arc if the node is connected to one or more other nodes by a probability arc;
naming each composite node by appending the names of the two related nodes from the original graph;
computing the weight using an appropriate weight composition function applied to the weights of the two related nodes from the original network graph; and
scaling the weight of the composite node by the probability value of the associated probability arc.

17. The method of claim 16, wherein the transforming the network graphs into the first graph further comprising:
copying the edge over to the second graph with the same end nodes and weight, if neither of the end nodes of the edge is connected to any other nodes by a probability arc;
adding an edge to the second graph between the corresponding nodes on the new graph, if one or both of the end nodes of the edge are connected to other nodes by one or more probability arcs, for each probability arc;
scaling the weight of each new edge by the probability value of an associated probability arc;
combining the edges into a single composite edge if an edge already exists between the nodes on the new graph;
adjusting the weight of the composite edge by combining the weights of the two edges using an appropriate weight composition function.

18. The method of claim 17, wherein the appropriate weight function is selected from a group consisting of summing, averaging, multiplying, division, and combinations of two or more thereof.

19. A system for usable state estimation from multi-network observations, comprising:
a framework architecture; and
two or more different types of networks connected to the framework architecture; and
wherein outputs from the networks comprise data combined into an estimate of a system state.

20. The system of claim 19, wherein:
the data are used to form models of the networks;
the models are unified to provide a unification model;
the unification model comprises unified multi-modal network data;
an estimate of the system state is derivable from the unified multi-modal network data;
the estimate of the system is obtained with scalable qualitative probabilistic algorithms;
the estimate of the system state is scalable;
the data from the outputs of the networks is graphed, with nodes and arcs, into graphs;
each network is represented by a graph;
the graphs are laid over each other and aligned with common nodes;
new arcs between the nodes are identified;
probabilities of connection are assigned to the arcs; and
the probabilities of connection indicate relationships among the nodes and information about the nodes.
